(19) United States
(12) Patent Application Publication
(10) Pub. No.: US 2008/0307174 A1
(43) Pub. Date: Dec. 11, 2008

(54) Dual Use Memory Management Library

(75) Inventors: Blaine Garst, Los Altos, CA (US); Bertrand Philippe Serlet, Palo Alto, CA (US)

Correspondence Address: WONG, CABELLO, LUTSCH, RUTHERFORD & BRUCCULERI LLP, 20333 SH 249, SUITE 600, HOUSTON, TX, 77070, US

(73) Assignee: Apple Inc., Cupertino, CA (US)

(21) Appl. No.: 11/760,580

(22) Filed: Jun. 8, 2007

(51) Int. Cl. G06F 13/00

(52) U.S. Cl. 711/160

(57) ABSTRACT

A dual-use library that is able to handle calls from programs requiring either reference count or garbage collected memory management is described. This capability may be provided by introducing a new assignment routine, assign( ), and instrumenting the reference count routines responsible for updating an object's reference count—e.g., addReference( ) and removeReference( ) routines. The assign( ), addReferenc( ) and removeReference( ) routines determine, at runtime, which memory management scheme is appropriate and execute the appropriate instructions (i.e., reference count or garbage collection specific instructions). The described dual-use library provides equivalent functionality as prior art two library implementations, but with a significantly lower memory footprint.

The invention relates generally to computer program memory management and, more particularly, to a runtime library that supports both reference count and garbage collected memory management. This disclosure is also related to U.S. patent application Ser. No. 11/608,345, entitled “Dynamic Memory Management,” filed 8 Dec. 2006, which is hereby incorporated by reference.

### BACKGROUND

Many modern programming languages allow a programmer to allocate and reclaim memory for data whose lifetime is not determined by the lexical scope of the routine that allocates the data. Memory of this type is said to be “dynamically” allocated. Dynamic memory may be manually created and destroyed by the programmer through, for example, explicit use of memory management library routines. Alternatively, dynamic memory may be managed by a program's run-time system. In this latter approach, while the programmer must request the dynamic allocation of memory for data, she does not need to determine when that memory is no longer needed—the program's run-time system does this automatically.

It is a generally recognized practice in computer programming to use what is known as a heap to provide for the dynamic creation (“allocation”) and recovery (“deallocation”) of regions of memory known variously as nodes, blocks, cells, or objects. Several heaps may be associated with a single program. Determining when a node is no longer referenced elsewhere in a program is often a very difficult task and is, therefore, a source of errors and excess memory use due to unused nodes that are not properly or timely deallocated.

One technique to provide memory management is referred to as “reference counting.” Reference counting memory management is based on counting the number of references to each cell or node from other, active cells or nodes. When the number of references to a cell or node is zero, it may be reclaimed and made available for use in subsequent memory allocation operations.

Another technique to provide dynamic memory management uses a garbage collected heap. In this approach, node deallocation is performed by runtime code rather than explicitly by program code. Many runtime-based languages provide this facility so that code written in these languages do not have to manage the complexity of determining when dynamically allocated nodes can be deallocated. Prior art garbage collection technology is discussed in Garbage Collection Algorithms for Automatic Dynamic Memory Management by Richard Jones and Rafael Lins, published by John Wiley & Sons, Copyright 1996. This reference is indicative of the prior art.

Prior art approaches to memory management use one library to support reference counting programs and a separate/different library to support garbage collected programs. Thus, a prior art runtime environment that supports the execution of both reference count and garbage collected applications requires that both sets of libraries (one for reference count operations and one for garbage collected operations) be loaded into a computer system's main memory. Since each shared library is typically very large (e.g., 100+ megabytes, MB), such an approach consumes a great deal of the system's memory resources. As used herein, the term “shared library” is a library where the code segments are shared across processes such that each process using the library doesn't need a private copy of the same code segment. Accordingly, it would be beneficial to provide a mechanism that supports both reference count and garbage collected memory management operations without incurring the memory overhead of separate and distinct library implementations.

### BRIEF DESCRIPTION OF THE DRAWINGS

FIG. 1 shows a table of prior art library source pseudo code used when making an assignment.

FIG. 2 shows a table of a addReference( ) routine (pseudo code) in accordance with one embodiment of the invention.

FIG. 3 shows a table of a removeReference( ) routine (pseudo code) in accordance with one embodiment of the invention.

FIG. 4 shows a table of an assign( ) routine (pseudo code) in accordance with one embodiment of the invention.

### SUMMARY

In one embodiment the invention provides a method to use a dual-use library. The method includes: receiving a first instruction that, when executed, invokes a first routine; determining the first instruction's required memory management scheme; and executing reference-count specific or garbage collection specific instructions based on whether the first instruction requires reference count or garbage collection memory management.

In another embodiment, the invention provides a dynamic memory management method. The method comprising the acts of receiving a call to a first routine in a runtime library from an executing process and performing a first one or more instructions in the first routine associated with reference count memory management if the process requires reference count memory management, otherwise performing a second one or more instructions in the first routine associated with garbage collection memory management if the entity requires garbage collection memory management.

Methods in accordance with the invention may be implemented as computer executable instructions stored in any media (e.g., a program storage device) that may be read by a computer system.

### DETAILED DESCRIPTION

The following description is presented to enable any person skilled in the art to make and use the invention as claimed and is provided in the context of a computer system executing the Mac OS® X operating system. (MAC OS is a registered trademark of Apple Inc.) Variations will, of course, be readily apparent to those skilled in the art. Accordingly, the claims appended hereto are not intended to be limited by the disclosed embodiments, but are to be accorded their widest scope consistent with the principles and features disclosed herein.

A shared library is generally formatted to identify itself as a shared library. The use of shared libraries is a well known practice that allows the sharing of read-only data across several processes in a multi-process system. The binary form of processor instructions constituting compiled higher level language constructs generally comprise the majority of shared memory. A Mac OS X based System has over 100 MB of shared processor instructions in its libraries. Libraries also generally include routines that are only invoked by other library routines. A library in accordance with the invention is one that includes routines for simultaneously supporting both reference count and garbage collected (generational and full) memory management—it is a “dual-use” library.

When a programmer creates a library for use with a reference count only memory management scheme, they will use reference counting operations to track the number of references to each object subject to dynamic memory management. Most often, these operations are embodied in routines that the programmer explicitly calls. This is not the only approach, however. For example, a programmer could include code to directly manipulate an object's counter or the programmer's compiler application could be modified to include the necessary counter operations each time an object assignment operator is present. While different programming environments may use different names, addReference( ) and removeReference( ) routines will be used herein to represent these actions.

In contrast, a programmer creating a library for use with a garbage collected only memory management scheme will not include any extra program code to track an object's reference count. FIG. 1 reflects prior art library source/pseudo code associated with the following assignment operation: fred→slot1=wilma. Here, “fred” and “wilma” are presumed to be objects and, further, fred is presumed to have a “slot1” attribute that may contain a pointer to an object (e.g., the wilma object).

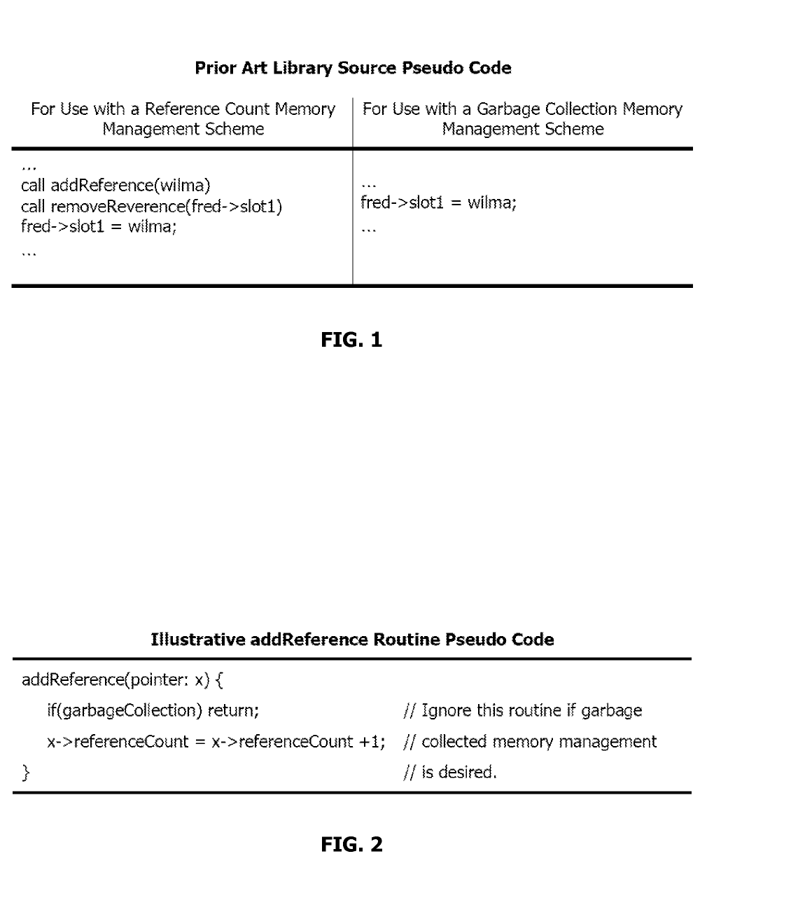

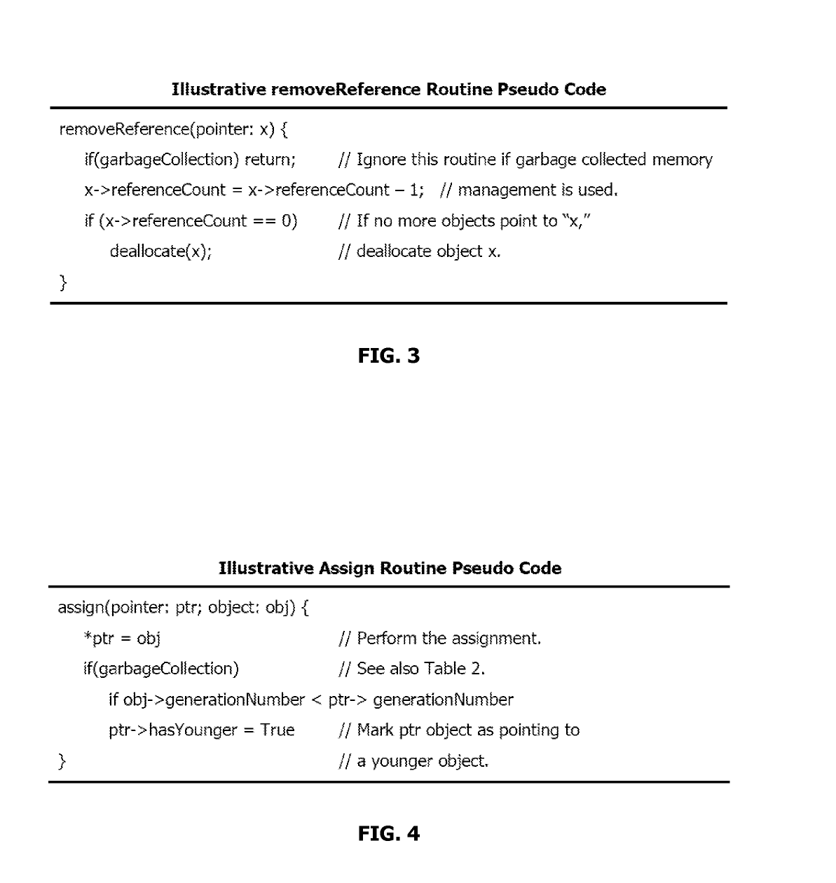

A dual-use library in accordance with the invention must be able to receive and correctly handle calls from programs requiring either reference count or garbage collected memory management. As described herein, this capability may be provided by introducing a new assignment routine, assign( ), and instrumenting the addReference( ) and removeReference( ) routines. In one embodiment, dual-use library source code for the assign( ), addReference( ) and removeReference( ) routines is shown in FIGS. 2, 3 and 4. Dual-use library source/pseudo code for the assign( ), addReference( ) and removeReference( ) routines in accordance with one embodiment of the invention is shown in FIGS. 2, 3 and 4. Here, objects created under a reference count memory management scheme are presumed to have an attribute that identifies the number of objects that point to it—the variable “reference Count.” Objects created under a garbage collected memory management scheme are presumed to have an attribute that identifies the object's generation or age—the attribute “generationNumber.” Finally, an application specific global value is assumed to signal whether the application making the library call was compiled to use reference count or garbage collection memory management—the “garbageCollection” variable. When garbagecollection is FALSE, the calling application requires reference count memory management. When TRUE, the calling application requires garbage collected memory management.

Implementation of a dual-use library in accordance with FIGS. 2-4 permits both garbage collected and reference counting memory management routines to co-exist within a common library. This, in turn, permits a dual-approach memory management operating environment with a significantly lower memory footprint than prior art approaches. By way of example, one embodiment of a dual-use library in accordance with the invention running within a Mac OS X environment is approximately 52 MB. Reference count only and garbage collected only libraries for the same operating environment are approximately 50 MB and 51 MB respectively. Accordingly, a dual-use library in accordance with the invention provides the same functionality but uses only 51% of the memory required by the prior art.

In one embodiment of the invention, a programmer developing a dual-use library would explicitly use the assign( ) routine. That is, rather than coding an assignment in the conventional way (e.g., fred→slot1=wilma), they would use an assignment routine such as that shown in FIG. 4—e.g., assign(fred→slot1, wilma). This approach requires no changes to the developer's compiler application. It does, however, require the programmer to use the assign( ) routine. An implementation in accord with this approach modifies the programming language (e.g., C, C++, Objective-C or Objective-C++) to introduce a new storage type which can be used to annotate a pointer type object. For example, a programmer may create a pointer and assign it a type that restricts its use to pointing to garbage collected heap memory, or to stack memory or to global memory. In embodiments which use this approach, every time a garbage collected pointer is assigned (e.g., a pointer of a type that is restricted to point to garbage collected memory such as, for example, garbage collected heap memory), garbage collected library routines may be invoked at run-time. If an assignment of a non-garbage collected pointer is made (e.g., involving a pointer to global memory), garbage collected memory management library routines are not called.

In another embodiment of the invention, a compiler can be provided that would automatically substitute all standard assignment operations (e.g., fred→slot1=wilma) with the newly defined assignment routine—e.g., assign(fred→slot1, wilma). This approach does not require the library developer to change how they program. It does, however, require a compiler application that has been modified to know about the assignment routine. In embodiments which use this approach, a compiler modified as described here would be invoked with a special flag. One value of this flag would indicate the program should be compiled to use garbage collected memory management. Another value of this flag would indicate the program should be compiled to use reference counting memory management. In this embodiment, the application programmer is tasked with calling the appropriate library routine (i.e., garbage collected or not) such that the proper routines are “compiled into” the final object code.

It will be recognized that there are a small set of coding patterns that work under non-garbage collected memory management schemes that don't work under garbage collected schemes. One such set centers around the difference in deallocation versus finalization order for a subgraph of objects whose last reference has been removed. In general, there is an ordering (e.g., top-down) of deallocation operations under non-garbage collected schemes. Under garbage collection operations, however, an object's graph is traversed in an arbitrary order when finalize calls are issued (if implemented). In such environments, a new finalize call into the dual-use library may be provided to account for the difference in deallocation patterns.

Another such pattern involves the use of object allocation caches. In general, object allocation caches don't work under garbage collection schemes whereas they do in reference counting schemes. It will be recognized that references to objects within objects or by global variables may be stored without the use of an addReference( ) routine to, in particular, avoid creating a reference cycle among a set of objects. It is a best practice to make these locations known to the garbage collector so that it preserves the logical ownership pattern that exists in a reference counting design. This can be done with storage annotation made visible to the compiler. It will also be recognized that references to objects may be held in traditional heap memory at the same time a garbage collected heap is provided. Such references need to be made with addExternal( ) and removeExternal( ) calls. These routines can be instrumented such that they invoke the addReference( ) and removeReference( ) routines if they are called by a program requiring reference count memory management.

Various changes in the components, circuit elements, as well as in the details of the illustrated operational methods and pseudo-code are possible without departing from the scope of the following claims. For example, the pseudo-code described herein is exemplary only. One of ordinary skill in the art of computer programming in general, and programming language and operating system design in particular, will recognize that the functionality of the described routines may be combined into fewer routines or divided into a larger number of routines. It will further be recognized that a dual-use library in accordance with the invention may be embodied in compiled code, assembly language code or an intermediate form of program code such as, for example Java® byte codes. (JAVA is a registered trademark of Sun Microsystems, Inc.) Further, acts in accordance with pseudo code FIGS. 2-4 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs” or field programmable gate array (“FPGAs”. These components may themselves form part of a larger system such as, for example, a personal computer system a server computer system and the like. Storage devices suitable for tangibly embodying program instructions include, but are not limited to: magnetic disks (fixed, floppy, and removable) and tape; optical media such as CD-ROMs and digital video disks (“DVDs”; and semiconductor memory devices such as Electrically Programmable Read-Only Memory (“EPROM”, Electrically Erasable Programmable Read-Only Memory (“EEPROM”, Programmable Gate Arrays and flash devices.

1. A dual-use library method, comprising:
receiving a first instruction to invoke a first routine;
determining a memory management scheme required by the first instruction;
executing one or more reference-count specific instructions in the first routine if the first instruction requires a reference count memory management scheme; and
executing one or more garbage collector specific memory management instructions in the first routine if the first instruction requires garbage collector memory management.

2. The method of claim 1, wherein the first routine comprises an assignment routine.

3. The method of claim 1, wherein the first routine comprises a routine to adjust a counter value, the counter value associated with an object.

4. The method of claim 3, wherein the counter value tracks how many entities reference the object.

5. The method of claim 3, wherein the counter value comprises a data structure in a memory.

6. The method of claim 5, wherein the counter value comprises a plurality of counter values.

7. The method of claim 1, wherein the reference-count and garbage collector specific memory management instructions comprise compiled instructions.

8. The method of claim 1, wherein the reference-count and garbage collector specific memory management instructions comprise assembly language instructions.

9. A program storage device, readable by a programmable control device, comprising instructions stored thereon for causing the programmable control device to perform the method of claim 1.

10. The program storage device of claim 9, wherein the program storage device comprises random access memory.

11. The program storage device of claim 10, wherein the random access memory comprises non-volatile random access memory.

12. The program storage device of claim 11, wherein the non-volatile random access memory comprises a magnetic disk device.

13. The program storage device of claim 10, wherein the random access memory comprises volatile random access memory.

14. A dynamic memory management method, comprising:
receiving, from an entity, a call to a first routine in a runtime library; and
performing a first one or more instructions in the first routine associated with reference count memory management if the entity requires reference count memory management, else
performing a second one or more instructions in the first routine associated with garbage collection memory management if the entity requires garbage collection memory management.

15. The method of claim 14, wherein the first routine comprises an assignment routine.

16. The method of claim 1, wherein the first routine comprises a reference count adjustment routine.

17. A program storage device, readable by a programmable control device, comprising instructions stored thereon for causing the programmable control device to perform the method of claim 14.

18. A computer system, comprising:
a processor;
a memory coupled to the processor; and
processor executable instructions stored in the memory for causing the processor to perform the method of claim 1.

19. The computer system of claim 18, wherein the processor executable instructions comprises an operating system level library.

20. The computer system of claim 19, wherein the operating system level library comprises a shared library.
